(19) United States
(12) Patent Application Publication
(10) Pub. No.: US 2003/0232250 A1
(43) Pub. Date: Dec. 18, 2003

(54) Proton-conducting film and method of manufacturing the same

(75) Inventors: Masayuki Nogami, Showa Nagoya (JP); Haibin Li, Showa Nagoya (JP)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/367,351

(22) Filed: Feb. 14, 2003

(30) Foreign Application Priority Data
Jun. 17, 2002 (JP) JP 2002-176490

(51) Int. Cl. H01M 10/40; C08J 5/22

(52) U.S. Cl. 429/313; 429/314; 521/27

(57) ABSTRACT

A proton-conducting film suitable for use as an electrolyte in a small fuel cell and a method of manufacturing the proton-conducting film. A proton-conductive film contains at least silicon, and has a plurality of pores three-dimensionally oriented with regularity. The pore diameter is smaller than 5 nm, and the film thickness is within the range from 100 to 10000 nm. The film may be manufactured by preparing a solution for making the film containing at least silicon, adding a surfactant to the solution, attaching the solution in film form to a surface of a substrate, and heating the film at 300 to 800° C. to remove the surfactant and to cause glass transition.

### CROSS-REFERENCE TO RELATED APPLICATIONS

This application claims priority to Japanese Patent Application No. 2002-176490, filed Jun. 17, 2002, which is incorporated by reference herein.

### BACKGROUND

The present invention relates to a proton-conducting film which can be used as an electrolyte in a fuel cell and a method of manufacturing the proton-conducting film.

A solid electrolyte having high proton conductivity is used in fuel cells. Film of a perfluorosulfonate polymer (e. g., available under the trade name Nafion) or the like is presently used as an electrolyte active in a temperature range from room temperature to a temperature of about 80° C. A number of other films similar to this have also been developed. Such polymer films, however, have a fundamental drawback in that they cannot be used at a temperature higher than 100° C.

A number of methods, etc., have been proposed to overcome such a drawback. For example, a method of modifying the side chain structure of the above-mentioned perfluorosulfonate polymer by a group having high heat resistance and a method of using a mixture of a perfluorosulfonate polymer and an inorganic compound have been proposed. The polymer films based on these methods are said to exhibit high proton conductivity at 100° C. or at a temperature slightly higher than 100° C. The polymer films obtained by these methods, however, have a problem that the stability of high proton conductivity over a long time period is low.

On the other hand, proton-conducting silica glass has been proposed as an electrolyte for fuel cells. For example, Japanese Patent Documents Nos. 2000-272932 and 2001-143723 disclose amorphous silica compacts having high proton conductivity through a temperature range from room temperature to a temperature of about 200° C. These compacts have a glass thickness larger than 0.1 mm and are called a bulk. A fuel cell using such a bulk as an electrolyte can be applied to stationary home generators, for example.

The above-described amorphous silica compact is not suitable for use as an electrolyte in a small fuel cell because it is a bulk. There is a demand for a fuel cell electrolyte suitable for use in a portable or vehicle fuel cell and having high proton conductivity through a temperature range from room temperature to a temperature of about 200° C.

### SUMMARY OF THE INVENTION

An object of the present invention is to provide a proton-conducting film suitable for use as an electrolyte in a small fuel cell and a method of manufacturing the proton-conducting film.

According to the present invention, it is possible to obtain a proton-conducting film suitable for use as an electrolyte in a small fuel cell and a method of manufacturing the proton-conducting film.

The present invention provides a proton-conductive film containing at least silicon, characterized by having a plurality of pores three-dimensionally oriented with regularity, the pore diameter being smaller than 5 nm, the film thickness being within the range from 100 to 10,000 nm. This film may contain phosphorous. Also, this film may contain SiO₂, may contain P₂O₅, and may further contain at least one of ZrO₂ and TiO₂. The pore diameter may be set to 3 nm or less.

The present invention also provides a method of manufacturing a proton-conducting film in accordance includes the steps of preparing a solution for making a film containing at least silicon, adding a surfactant to the solution, attaching the solution in film form to a surface of a substrate, and heating the film at 300 to 800° C. to remove the surfactant and to cause glass transition. The solution for making the film may contain phosphorous. Also, the surfactant is C₁₆H₃₃ (OCH₂CH₂)₁₀OH that is the product of the reaction of cetylalcohol (C₁₆H₃₃OH) with 10 moles of oxirane (ethoxide, EO) . It is abbreviated: “C₁₆EO₁₀”. The surfactant is also H₃C (OCH₂CH₂)₁₀₆(OCH₂CH₂CH₂)₇₀(OCH₂CH₂)₁₀₆CH₃ or HO(OCH₂CH₂)₁₀₆(OCH₂CH₂CH₂)₇₀(OCH₂CH₂)106OH.

A proton-conducting film suitable for use as an electrolyte in a small fuel cell and a method of manufacturing the proton-conducting film can be obtained by such constitution.

### BRIEF DESCRIPTION OF THE DRAWINGS

An embodiment of the present invention will be described below in detail with reference to the drawings, in which:

FIG. 1 shows a graph X-ray diffraction patterns of silica films made by respectively using C₁₆EO₁₀ and CTAB as templates and by being heated at 400° C. for eight hours;

FIG. 2 shows a graphical depiction of the conductivities of silica films made by respectively using C₁₆EO₁₀ and CTAB as templates and by being exposed to water vapor at 50° C.; and

FIG. 3 shows a graphical depiction of a pore size distribution in a silica film made by using C₁₆EO₁₀, the pore size distribution being measured by using a BJH method, a nitrogen adsorption/desorption isotherm being shown in an inset section.

### DETAILED DESCRIPTION

The present invention aims mainly to control the pore structure in a film formed by using an interfacial silica-surfactant self-assembly technique. This self-assembly method enables mesoporous silica films to grow in solid-liquid and liquid-vapor interfaces above the critical micell concentration. Many reports have been made on the formation of surfactant-templated mesoporous silica membranes, which can be used for catalysis, sensing and separation. A proton-conducting glass has high conductivity because of the fast proton mobility under the coexistence of molecular water absorbed inside the inner pore surfaces. Therefore, a surfactant-templated mesoporous silica film with a large pore surface area and a regular pore arrangement is appropriate as a protonic-conducting film.

A precursor solution was prepared by addition of surfactants to polymeric silica sol in a convenient two-step procedure. The surfactants used as structure-directing agents were cationic CTAB (cetyltrimethylammoniumbromide) (CH₃(CH₂)₁₅N+(CH₃)₃Br) and non-ionic C₁₆EO₁₀C₁₆H₃₃(OCH₂CH₂)₁₀OH). First, tetraethoxysilane (TEOS), propanol, water and HCl in the 1:3.8:1:8×10⁻⁵ molar ratios were mixed at 60° C. for 1 hour. After adding the additional water and HCl, the sol was further stirred at 70° C. for 1 hour. A surfactant solution was separately prepared by dissolving a surfactant in propanol, and then slowly added under stirring to the previously prepared sol. The sol was then stirred at room temperature for another 1 hour. The final reactant mode ratios were 1 TEOS: 11.4 Propanol: 5 H₂O:0.004 HCl: 0.10 Surfactant. An ITO glass sheet was used as a substrate. Prior to deposition, the substrate was degreased with a neutral detergent, washed in distilled water using ultrasound and then rinsed with acetone. Gel film was deposited by dipping the substrate into the sol and by withdrawing the substrate at a constant rate of 25 cm/min, followed by heating at 400° C. for 8 hours in air to remove the surfactants and cause grass transition. Transparent crack-free film with a thickness of ˜0.5 μm was obtained.

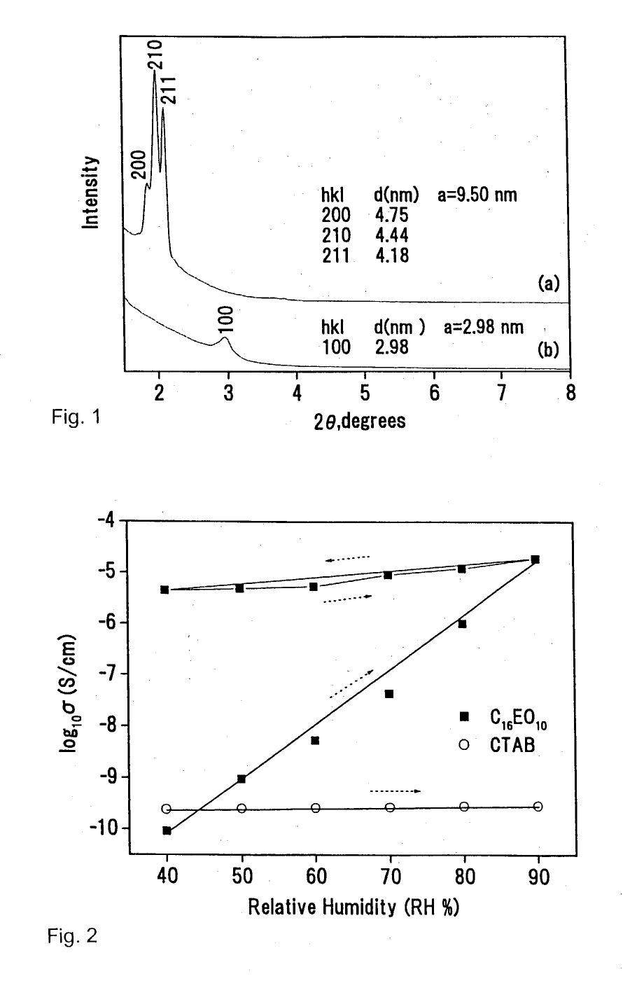

FIG. 1 shows X-ray diffraction (XRD) patterns of silica films formed by using two different surfactants and heated. In the film formed by using C₁₆EO₁₀ as a template, three strong peaks are observed at a low angle of 2θ=1.5−2.5°, which can be indexed as (200), (210) and (211) reflections of a highly ordered three-dimensional cubic (Pm3n) mesostructure. From the d-spacing value 4.75 for the (200) reflection, the size of the unit cell is estimated as a=9.5 nm. On the other hand, in the XRD pattern for the film formed by using CTAB, one well-resolved peak is observed at around 3°, corresponding to the d-spacing 2.98 nm. This XRD pattern is consistent with a two-dimensional hexagonal mesoporous structure and the peak is indexed as (100) reflection, indicating that the pore channels are oriented parallel to the substrate surface.

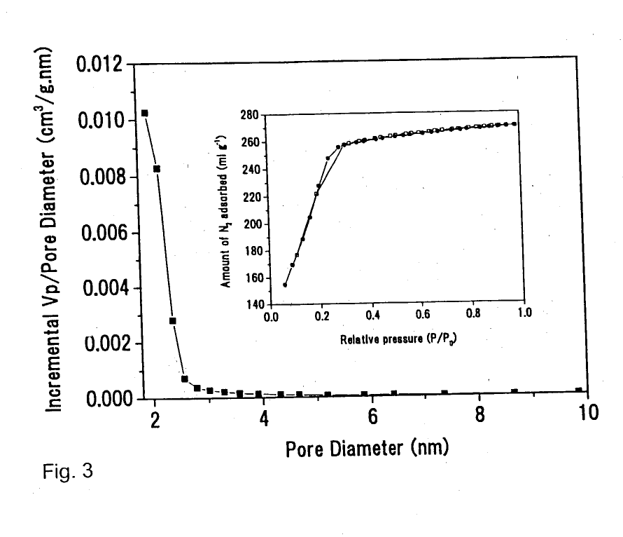

When the porous films are exposed to ambient atmosphere, they absorb water. In the previous papers, we discussed the conductivity of porous silica glasses containing both hydroxyl bonds and water molecules. The proton conduction is promoted by dissociation of protons from hydroxyl bonds on the pore surfaces and by proton hopping between hydroxyl groups and water molecules. The conductivity increases with the increase in the content of the adsorbed water. In this sense, both the films made in this study should be similar to each other in dependence of the conductivity on humidity. However, the result was entirely unexpected as shown in FIG. 2, where the conductivities, measured at 50° C., are plotted as a function of relative humidity. The conductivity of the sample prepared using CTAB is low, 2.5×10⁻¹⁰ S/cm, and independent of the relative humidity. As shown in the pattern (b) in FIG. 1, the silica film formed by using CTAB has pore structure with channels parallel to the substrate surface such as to provide no path for proton transfer between the electrodes, even if absorbing the water in the pores, resulting in low conductivity. In contrast, the conductivity of the film formed by using C₁₆EO₁₀ changes largely in the relative humidity range from 40 to 90% and increases substantially linearly with increasing humidity. The conductivity 1.9×10⁻⁵ S/cm at 90% RH is comparable to that of porous silica glass. The film formed by using C₁₆EO₁₀ has a pore structure in which pores are connected in a three-dimensional meshwork. Water molecules from ambient atmosphere can enter the film through accessible pore channels and act as the path for movement of protons. Thus, it is apparent that the conductivity of the silica films increases with the increase in water content. In FIG. 2, each arrow indicates the direction of change in relative humidity. The thickness of the two films in this example measured with a surface roughness tester is −0.5 μm.

Of further interest in FIG. 2 is that the film formed by using C₁₆EO₁₀ exhibits high conductivity when the humidity is reduced from 90 to 40%RH. This result suggests that the film exposed to air of high humidity retains water in the pores and exhibits high conductivity irrespective of variation in humidity. The sample made by using C₁₆EO₁₀ was measured by using a nitrogen sorption isotherm to find small hysteresis at around 0.25 partial pressure, indicating the presence of mesopores (inset in FIG. 3). In the graph inset in FIG. 3, blank square marks and solid round marks indicate adsorption and desorption, respectively. The nitrogen adsorption/desorption isotherm was measured at 77K with NOVA-1000 apparatus (Quantachrome).

The pore surface area and the pore volume measured are 821 m²/g and 0.42 ml/g, respectively. The size distribution of pores measured by using BJH method is shown in FIG. 3. It is to be noted that the film is composed of pores of a diameter smaller than 2.5 nm. Silica film having such three-dimensional mesopores and having a large surface area and a large pore volume is capable of absorbing a large amount of water in pores. Among adsorbed water molecules, those in the first layer in the pore surface are strongly hydrogen bonded with the hydroxyl groups, while the other water molecules form a liquid state in pores. Amounts of water in the films were measured through infrared absorption ranging from 3700 to 3000 cm⁻¹, ascribable to the existence of hydroxyl and water. It was found that the water content in the films exposed in the high humidity of 90%RH was not changed even after reducing the humidity down to 40%. It can be understood that when water molecules are confined in a small space, the characteristics of these water molecules are different from those of water molecules not confined. The motion of the confined water is restricted and maintained in the small pores, so that the proton conductivity is kept high. This finding is very important with respect to use of the film as an electrolyte membrane in an actual fuel cell, because it ensures simpler water control and, hence, a remarkably reduced maintenance cost.

The basic composition of the proton-conducting film in accordance with the present invention is a glass film containing SiO₂ or P₂O₅ and SiO₂. For example, oxides such as ZrO₂ and/or TiO₂ may be added thereto. P₂O₅ contributes largely to the effect of increasing the proton conductivity but it is inferior in chemical durability. ZrO₂ and TiO₂ can act to improve the chemical durability of the glass.

This glass film is made by controlling the size of the diameter and directionality of pores in the film in order to obtain high proton conductivity. More specifically, this glass film has a plurality of pores oriented with three-dimensional regularity, the pore diameter is smaller than 5 nm, and the film thickness is in the range from 100 to 10000 nm. This glass film can be made by a sol-gel method. According to the present invention, film forming on a substrate using a raw-material which is a predetermined solution containing a surfactant is performed to make a film in which pore characteristics (pore diameter and directionality) are controlled according to the molecules of the surfactant. After film forming, the glass film is heated at 300 to 800° C. to remove the surfactant. The film thus made has improved heat resistance and chemical stability and is free from defects pointed out with respect to polymers.

For example, as the raw material according to the present invention, a material selected from metal alkoxides, such as Si (OC₂H₅)₄, Si (OCH₃)₄, PO(OCH₃)₃, and PO(OC₂H₅)₃, and chlorides or oxides, such as H₃POCl₃ and H₃PO₄ may be used. Each of these materials can be used in the form of a solution suitable for film forming. However, the raw material according to the present invention is not limited to these materials.

The glass film contains SiO₂ or P₂O₅ and SiO₂, and ZrO₂ and/or TiO₂ for example may be added. It is preferred that the SiO₂ content in this case be 50% or more. If the SiO₂ content is smaller than this value, the glass film cannot be sufficiently uniform in structure and does not have improved chemical durability and thermal stability. Since P₂O₅ contributes largely to the proton conductivity, it is desirable that P₂O₅ be contained. However, it is preferable to limit the P₂O₅ content to 30% at the maximum. If the P₂O₅ content is larger than this value, a deterioration in film durability results. ZrO₂ and TiO₂ do not contribute an improvement in the proton conductivity but they have the effect of greatly improving the chemical durability of the film.

Film is formed on a substrate by using the above-described solution and is thereafter heated, thereby obtaining porous glass film. To control the size and directionality of pores formed in the film in this process, a solution to which an organic material is added is prepared and the glass film is made by using the solution as a raw material. An example of a process for making the glass film will be described.

First, a solution for making a film having high proton conductivity is prepared by using as a raw material a material selected from metal alkoxides, such as Si(OC₂H₅)₄, Si(OCH₃)₄, PO(OCH₃)₃, and PO(OC₂H₅)₃, and a chlorides or oxides, such as H₃POCl₃ and H₃PO₄. The above-described raw material is added to alcohol and water is then added to cause reaction For example, Si(OC₂H₅)₄ is put in ethanol and water or a mixture solution of water and ethanol is then added while solution is stirred. The mixed solution is further stirred for hydrolysis of Si(OC₂H₅)₄, thereby forming a polymeric structure similar to the silica structure. To promote the hydrolysis reaction, hydrochloric acid or nitric acid may be used as a catalyst for the reaction. The reaction is thereby made to proceed faster. Thereafter, PO(OCH₃)₃, PO(OC₂H₅)₃ or the like is added and the solution is stirred for reaction with the silica structure, thereby making the solution uniform. Further, a metal alkoxide of a metal ion such as Ti is added to prepare the solution. If during reaction the solution is heated at about 50° C., the reaction can be completed in a shorter time period. However, it is not necessary to perform heating. Thereafter, a surfactant is added and stirring is continued. The uniform solution for making a film is thus obtained. A substrate is immersed in the prepared solution and withdrawn from the solution, or the solution is applied dropwise to the surface of the substrate while the substrate is being rotated. A film in a gel state is thereby attached to the surface of the substrate. Thereafter, the film is heated at 300 to 800° C. to remove the surfactant and to cause glass transition. The film is thereby obtained as glass, thus making the desired film having high proton conductivity.

As a solution concentration, 1 to 40% (mass %) may be set in correspondence with the oxide in the glass finally obtained (in terms of the amount of SiO₂ and P₂O₅ or the like). If the solution concentration is higher than this value, the film is cracked while the gel film is obtained or during heating, resulting in failure to obtain the desired film. Ordinarily, the film can be obtained in a good condition when the solution concentration is 5 to 30%.

It is preferable to set the thickness of the obtained film to 100 to 10000 nm. The film thickness may be set to a value below this range. However, if the film is excessively thin, supply of water into pores and control of keeping of water in the pore become difficult. If the film is excessively thick, the conductivity is reduced and the film cannot be advantageously used in a small membrane fuel cell.

As the surfactant, C₁₆H₃₃(OCH₂CH₂)₁₀OH (referred to as C₁₆EO₁₀, hereinafter), (OCH₂CH₂)₁₀₆ (OCH₂CH₂CH₂)₇₀(OCH₂CH₂)₁₀₆, or the like may be used. The role of the surfactant is very important. The size and directionality of mores are determined by the surfactant. The surfactant largely influences the proton conductivity finally determined. A porous glass film may be made without using a solution prepared without adding any surfactant. However, the proton conductivity in such a case is considerably low and the glass film cannot be applied to fuel cells. It is possible to reduce the size of pores to 5 nm or less and further to 3 nm or less by using the surfactant. In small pores thus formed, water molecules adsorbed are confined with stability. Even when the external humidity is reduced, the water molecules once adsorbed stay in the pores with stability. It is possible to increase the proton conductivity by increasing the amount of water molecules remaining in the pores.

If the above-described surfactant is used, pores can be oriented with regularity so as to be opened three-dimensionally relative to the film. High conductivity in the electrode direction is obtained thereby. In a case where the openings are open only in directions parallel to the film, the conductivity is high in the directions parallel to the substrate (film), but the conductivity according to the present invention cannot be obtained and an application to fuel cells cannot be achieved.

The present invention will be described in more detail with respect to examples thereof. However, the present invention is not limited to the examples described below.

### EXAMPLE 1

A mixture of 347 g of Si(OC₂H₅)₄, 101 g of water, 68 g of ethanol and 0.1 g of hydrochloric acid was prepared and stirred for 1 hour. Then 100 g of C₁₆EO₁₀ was added and the mixture was stirred for 1 hour. Further, 16 g of water was added and the mixture was stirred for 1 hour, thereby preparing a solution. A substrate (a metallic, ceramic or glass plate) was immersed in the solution, then withdrawn from the solution, and dried by being left in a room. A film material was thereby attached to the surface of the substrate. The substrate with the film was set in an electric furnace to be heated at 400° C. A colorless transparent film was thereby obtained. The film had a thickness equal to or smaller than 500 nm and was amorphous. A gas sorption isotherm was obtained by a nitrogen adsorption method to examine the size and distribution of pores. Results such as those shown in the graph inset in FIG. 3 were thereby obtained. The diameter and proportion of the pores were determined calculation using these results. It was found that the size of ant of the pores is smaller than 2.5 nm. The X-ray diffraction pattern of the film was measured and the result of this measurement was as represented by the pattern (a) shown in FIG. 1. It was understood from the configuration of the measured peaks that the pores were three-dimensionally distributed with regularity.

### EXAMPLE 2

A mixture of 308 g of Si(OC₂H₅)₄, 100 g of water, 68 g of ethanol and 0.1 g of hydrochloric acid was prepared and stirred for 1 hour. After 22 g of PO(OCH₃) was added, 100 g of C₁₆EO₁₀ was added and the mixture was stirred for 1 hour. Further, 16 g of water was added and the mixture was stirred for 1 hour, thereby preparing a solution. Film forming from this solution was performed in the same manner as that in Example 1. Substantially the same results as those in Example 1 were also obtained.

### EXAMPLES 3 to 7

After addition of PO(OCH₃)₃ in Example 2, and before addition of C₁₆EO₁₀, Zr(OC₄H₉)₄ or Ti(OC₃H₇)₄ was added as shown in Table 1, thus preparing a solution. Substantially the same results were obtained.

The glass compositions (mol %) and the amounts of raw material (g) in Examples 1 to 7 are as shown in Table 1.

TABLE 1

| | Example 1 | Example 2 | Example 3 | Example 4 | Example 5 | Example 6 | Example 7 |
|---|---|---|---|---|---|---|---|
| Glass | | | | | | | |
| composition | | | | | | | |
| SiO₂; | 100 | 95 | 90 | 90 | 90 | 90 | 90 |
| P₂O₅; | 0 | 5 | 10 | 5 | 5 | 7 | 7 |
| ZrO₂; | 0 | 0 | 0 | 5 | 0 | 3 | 0 |
| TiO₂; | 0 | 0 | 0 | 0 | 5 | 0 | 3 |
| Raw | | | | | | | |
| material | | | | | | | |
| Si(OC₂H₅)₄; | 347 | 308 | 274 | 279 | 288 | 277 | 282 |
| PO(OCH₃)₃; | 0 | 22 | 41 | 21 | 21 | 29 | 30 |
| Zr(OC₄H₉)₄; | 0 | 0 | 0 | 28 | 0 | 17 | 0 |
| Ti(OC₃H7)₄; | 0 | 0 | 0 | 0 | 22 | 0 | 13 |

In the examples, Si(OC₂H₅)₄, PO(OCH₃)₃, Zr(OC₄H₉)₄ and/or Ti(OC₃H₇)₄ was used as a raw material. However, these materials are not exclusively used. Any other alkoxide, oxide or chloride may also be used.

A film is formed on a substrate by using the solution thus prepared. The film forming method is such that the substrate is immersed in the solution and then withdrawn from the solution, and the solution is thereby attached to the surface of the substrate. The substrate with the solution is left in a room or heated to evaporate alcohol, etc. A film in gel form is thereby formed. Alternatively, the solution is applied dropwise to the surface of the substrate in a rotated state to uniformly form a film.

The specimen obtained in this manner is heated in air. Heating at 300 to 800° C. may be performed to make the desired proton-conducting glass film. If the heating temperature is lower than 300° C., the organic components are not sufficiently evaporated, resulting in failure to obtained the desired film. If the heating temperature is higher than 800° C., the pores are reduced and sufficiently high conductivity cannot be obtained.

The electrical conductivity was measured as described below. Film forming was performed on a substrate with an electrode by the above-described method, and a gold electrode was attached to a surface of the substrate: Thereafter, the specimen was placed in a constant-humidity atmosphere and the resistance of the specimen was measured by an ac impedance method.

The measurement results with respect to Example 1 were as described below. At a temperature of 50° C. and a humidity of 40%, the resistance was 4.8 MΩ. When the humidity was set to 90%, the resistance was lower, 20 Ω. Even when the humidity was thereafter reduced, no significant change in resistance value was observed. Even at the humidity 40%, the resistance was 90 Ω. The measured resistance value is converted into the conductivity. The conductivity is expressed as a function of humidity, as shown in the graph of FIG. 2. From this result, it can be understood that the glass film has high conductivity.

TABLE 2

| | Example 1 | Example 2 | Example 3 | Example 4 | Example 5 | Example 6 | Example 7 |
|---|---|---|---|---|---|---|---|
| Film | 500 | 500 | 500 | 500 | 500 | 500 | 500 |
| thickness | | | | | | | |
| (nm) | | | | | | | |
| 50/90 | 20 | 0.5 | 0.1 | 5 | 1 | 0.8 | 0.8 |
| 50/40 | 90 | 0.5 | 0.2 | 9 | 4 | 2.5 | 2.5 |

In Table 2, each of 50/90 and 50/40 represents temperature/humidity (%). The resistance in each example was measured at 50/90 and thereafter measured at 50/40. It can be understood from Table 2 that when humidity was reduced from 90 to 40%, the resistance was not changed largely, that is, no significant reduction in conductivity was caused.

### COMPARATIVE EXAMPLE 1

A mixture of 347 g of Si(OC₂H₅)₄, 101 g of water, 68 g of ethanol and 0.1 g of hydrochloric acid was prepared and stirred for 1 hour. Then 16 g of water was added and the mixture was stirred for 1 hour, thereby preparing a solution, from which a film was formed. The film was made in the same manner as Example 1 except that C₁₆EO₁₀ was not added. The average more diameter was 4 nm. In the X-ray diffraction pattern, no peaks such as those in the pattern (a) shown in FIG. 1 were recognized. No directionality of the pore distribution was found. The resistance was excessively high, 1 MΩ. Thus the characteristics of the obtained film were undesirable ones.

### COMPARATIVE EXAMPLE 2

A film was made by preparing a solution using CH₃(CH₂)₁₅N⁺(CH₃)₃Br⁻ in place of C₁₆EO₁₀ in the process for Example 1. The X-ray diffraction pattern of the obtained film was measured. The result was as represented by the pattern (b) shown in FIG. 1. From the configuration of the peaks in the obtained pattern, it was understood that pores are distributed parallel to the film surface. In such a film, since the directionality of pores is not perpendicular but parallel to the film, the conductivity is low and the desired film characteristics cannot be obtained. The relationship between the conductivity and humidity was as indicated by blank circular marks in FIG. 2, that is, the conductivity was low.

Thus, an amorphous film containing phosphorous and silica can be made as a film having high proton conductivity. The obtained film exhibits high proton conductivity when the ambient humidity is increased so that water is adsorbed therein. After water has been adsorbed in the film, the water keeps absorbed in the film even when the ambient humidity is reduced. Thus, the film can be used with stability in a fuel cell even under a low-humidity condition. The proton-conducting film in accordance with the present invention can be formed from a material containing at least silicon (Si) and hydrogen or silicon (Si), phosphorous (P) and hydrogen among metal ions such as phosphorous (P), silicon (Si), zirconium (Zr), titanium (Ti), and hydrogen (H). In this case, the diameter of pores formed in the film is smaller than 5 nm or 3 nm, and the pores are three-dimensionally arranged with regularity. The thickness of the film is not particularly limited. However, it may be set within the range from 100 nm to 10000 nm from the viewpoint of advantage in application. Thus, an inorganic film having high proton conductivity through a wide temperature range from room temperature to about 200° C. It is possible to realize a thin small fuel cell by using this glass film having high proton conductivity.

What is claimed is:

1. A proton-conductive film comprising at least silicon wherein the film has a plurality of pores three-dimensionally oriented with regularity and having a pore diameter of less than 5 nm and wherein a thickness of the film is within a range from 100 to 10,000 nm.

2. The proton-conductive film as recited in claim 1, further comprising phosphorous.

3. The proton-conductive film as recited in claim 1, further comprising SiO₂.

4. The proton-conductive film as recited in claim 3, further comprising P₂O₅.

5. The proton-conductive film as recited in claim 3, further comprising at least one of ZrO₂ and TiO₂.

6. The proton-conductive film as recited in claim 1, wherein the pore diameter is less than 3 nm.

7. A method of manufacturing a proton-conducting film, the method comprising:
preparing a solution for making a film containing at least silicon;
adding a surfactant to the solution;
attaching the solution in film form to a surface of a substrate; and
heating the film at 300 to 800° C. so as to remove the surfactant and cause glass transition.

8. The method of manufacturing a proton-conducting film as recited in claim 7, wherein the solution for making the film contains phosphorous.

9. The method of manufacturing a proton-conducting film as recited in claim 7, wherein the surfactant includes C₁₆H₃₃(OCH₂CH₂)₁₀OH.

10. The method of manufacturing a proton-conducting film as recited in claim 7, wherein the surfactant includes H₃C(OCH₂CH₂)₁₀₆(OCH₂CH₂CH₂)₇₀(OCH₂CH₂)₁₀₆CH₃.
